(19) United States
(12) Patent Application Publication
(10) Pub. No.: US 2010/0209709 A1
(43) Pub. Date: Aug. 19, 2010

(54) BINDER-CONSOLIDATED CELLULOSE BEADS

(75) Inventors: Markus Braun, Heidelberg (DE); Rainer Dyllick-Brenzinger, Neustadt (DE); Matthias Maase, Mendham, NJ (US); Frank Stein, Bad Duerkheim (DE); Megan Turner, Florham Park, NJ (US); Eric Uerdingen, Speyer (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/678,418

(22) PCT Filed: Sep. 9, 2008
(86) PCT No.: PCT/EP2008/061892

§ 371 Date: Mar. 16, 2010

Related U.S. Application Data
(60) Provisional application No. 60/972,956, filed on Sep. 17, 2007.

(51) Int. Cl. B32B 5/00; C08B 37/00; C08G 63/91

(52) U.S. Cl. 428/402; 536/56; 525/54.21

(57) ABSTRACT

A binder-consolidated cellulose bead or lignocellulose bead (referred to as consolidated bead for short), obtainable by
mixing of cellulose or lignocellulose beads with a binder
   and subsequent crosslinking of the binder.

The invention relates to binder-consolidated cellulose beads or lignocellulose beads (referred to as consolidated beads for short), obtainable by mixing of cellulose or lignocellulose beads with a binder and subsequent crosslinking of the binder.

Cellulose is a raw material available in large amounts and can be obtained by various digestion processes from wood. Depending on the type of digestion process and the manner in which it is carried out, the cellulose obtained also comprises lignin as a constituent (lignocellulose).

The cellulose can be processed to give fibers which in turn are used for the production of textiles. A use which has not been very important to date is the processing of cellulose to give beads. Such beads are used, for example, as filling and carrier material in chromatography columns, as described, for example, in EP-A-264 853. The beads described there are relatively small and have a mean particle diameter of less than 300 μm.

For further uses of cellulose beads, beads as large as possible and with a strength as high as possible are required or desirable. Large beads having sufficient strength are generally advantageous in transport, storage and disposal.

The preparation of large beads by coagulation of industrial viscose (cellulose content 8.2%) is described in U.S. Pat. No. 4,055,510; after drying, 85% by volume of the beads according to example 1 of the US patent have a particle diameter of from 0.15 to 0.35 mm. However, these beads still do not have sufficient strength and are therefore not suitable for uses in which the strength and in particular the avoidance of small-particle abrasion or decomposition products due to impact or shear loads are important.

The consolidation of fibers, including cellulose fibers, with binders is generally known and is described, for example, for some binder classes in EP 651 088, WO 97/31036, U.S. Pat. No. 4,332,586 and EP 698 627. However, no information about the preparation of the beads is to be found there.

An object of the present invention was beads which are as large and strong as possible and comprise cellulose or lignocellulose and which, owing to their size and strength, are advantageous in storage, transport and disposal and have advantageous performance characteristics, for example the high impact strength and little abrasion in the desired use.

Accordingly, the consolidated beads defined at the outset were found.

The preparation of the consolidated beads according to the invention can be effected by mixing of cellulose beads or lignocellulose beads with a binder and subsequent crosslinking of the binder.

Required starting materials are therefore cellulose beads or lignocellulose beads and the binder.

Regarding the Starting Materials

Here, the term cellulose is understood as meaning natural or subsequently chemically modified cellulose. Suitable chemically modified cellulose is, for example, cellulose ester, cellulose ether, cellulose reacted with amino compounds or subsequently crosslinked cellulose. Cellulose acetate and cellulose butyrate may be mentioned in particular as cellulose esters, and carboxymethylcellulose, methylcellulose and hydroxyethylcellulose may be mentioned in particular as cellulose ethers. In addition cellulose allophanates and cellulose carbamates may also be mentioned.

In particular, the molecular weight of the natural cellulose can also be reduced by chemical or enzymatic degradation reactions or by addition of bacteria (bacterial degradation). The cellulose may also comprise low molecular weight polysaccharides, so-called polyoses or hemicelluloses (degree of polymerization in general only from 50 to 250); the proportion of such low molecular weight constituents is, however, in general less than 10% by weight, in particular less than 5% by weight or less than 3% by weight, based on the cellulose.

The term lignocellulose is understood as meaning natural or modified cellulose, as described above, which may be present as a mixture with lignin or chemically bonded to lignin.

Suitable beads may consist of cellulose or of lignocellulose. In the case of lignocellulose and the beads obtained therefrom, the proportion of lignin is, for example, from 5 to 60% by weight, in particular from 5 to 40% by weight, based on the total weight of the beads.

As already mentioned at the outset, cellulose or lignocellulose can be obtained by various digestion processes from wood. The working-up of the suspensions obtained thereby and, if appropriate, modification of the cellulose or lignocellulose obtained are known.

The preparation of beads can be effected by coagulation of suspensions comprising cellulose or lignocellulose, as described, for example, in U.S. Pat. No. 4,055,510.

Prior to mixing with the binder, the beads preferably already have the desired minimum size.

Preferably, at least 50% by weight of the beads, particularly preferably at least 80% by weight of the beads, have a particle diameter greater than 800 μm (21° C., 1 bar, determined by sieve analysis).

Preferably at least 95% by weight, in particular at least 99% by weight, of the consolidated beads have a particle diameter of less than 1500 μm.

The binder may be present, and may be used, in the form of a solution or dispersion or as a 100% system (i.e. free of water and solvent).

Particularly suitable binders are binders which are soluble in water or in an organic solvent. They are particularly preferably binders which are soluble in water.

The binders are used in particular in the form of their solutions in water or in an organic solvent or mixtures thereof. Aqueous binder solutions in water or mixtures of water with solvents which are miscible with water are particularly preferred. Binder solutions in water are very particularly preferred.

The content of the binder in the solution or dispersion is preferably at least 15% by weight.

The binder must be crosslinkable. For this purpose one-component binders, which are self-crosslinkable, are suitable. Two-component binders comprising two components which are crosslinkable with one another are also suitable.

The crosslinking reaction is preferably a condensation reaction, in particular a reaction in which water or an alcohol, particularly preferably water, is eliminated.

For example, water-soluble formaldehyde resins are suitable as binders.

Known formaldehyde resins are, for example, polymers of amino compounds and formaldehyde (amino-formaldehyde resins) or polymers of hydroxy compounds with formaldehyde (phenyl-formaldehyde resins).

Aminotriazine resins and urea resins have become particularly important as amine-formaldehyde resins.

Aminotriazine resins are reaction products of aminotriazines with formaldehyde.

Suitable aminotriazines are, for example, melamine, benzoguanamine and acetoguanamine, and melamine is preferred.

Reaction products with formaldehyde are the at least partly methylolated aminotriazines (reaction only with formaldehyde) and, if appropriate, also etherified aminotriazines (ether cation of the methylol group with an alcohol).

Particularly suitable aminotriazine resins are also the condensates of methylolated and, if appropriate, etherified aminotriazines. These condensates are, however, preferably still soluble in water.

At least partly methylolated and etherified melamine and corresponding compounds which comprise a plurality of melamine nuclei, for example 2 to 5 melamines bridged via methylol groups, or mixtures thereof are preferred. Preferred aminotriazines comprise on average from 1 to 3 melamine nuclei, in particular 1 melamine nucleus, per molecule.

A suitable aminotriazine is, for example, hexamethoxymethylolmelamine (each amino group of the melamine is methylolated with 2 formaldehyde groups, and each methylol group is etherified with methanol).

Preferred aminotriazine resins have a water solubility of at least 500 g/liter of water (21° C., 1 bar).

Urea resins are reaction products of urea or urea derivatives with formaldehyde.

Urea is very particularly preferred.

Reaction products of urea or urea derivatives with formaldehyde can be obtained, for example, by acidic condensation.

Phenol-formaldehyde resins are reaction products of phenol or derivatives of phenol, preferably with formaldehyde.

In particular, cresols may be mentioned as derivatives of phenol. Soluble reaction products of formaldehyde with phenol or phenol derivatives are known, for example, as novolaks.

Preferred formaldehyde resins are the amino-formaldehyde resins.

Compared with the formaldehyde resins, preferred binders are those which comprise acid or acid anhydride groups, in particular carboxyl or carboxylic anhydride groups, and comprise a crosslinking agent or crosslinking groups which crosslink with the acid or acid anhydride groups, in particular carboxyl or carboxylic anhydride groups.

The crosslinking agents are preferably compounds having hydroxyl groups or amino groups or the crosslinking groups are preferably hydroxyl groups or amino groups.

The binders may comprise acid or acid anhydride groups and the crosslinkable groups in the same polymer (one-component binder); they may also comprise a polymer having acid or acid anhydride groups and a separate crosslinking agent (two-component binder).

Two-component binders comprising a polymer having acid or acid anhydride groups and a crosslinking agent having hydroxyl groups or amino groups, particularly preferably having hydroxyl groups, are particularly preferred.

Suitable polymers having an acid or acid anhydride group are obtainable in particular by free radical polymerization of ethylenically unsaturated compounds (monomers).

Preferred polymers consist of from 5 to 100% by weight, particularly preferably from 10 to 100% by weight and very particularly preferably from 30 to 100% by weight of monomers having at least one acid or acid anhydride group. These are preferably a carboxyl group or carboxylic anhydride group.

Monomers having a carboxyl group are, for example, C3- to C10-monocarboxylic acids, such as acrylic acid, methacrylic acid, ethylacrylic acid, allylacetic acid, crotonic acid, vinylacetic acid or maleic acid monoesters.

Particularly preferred polymers consist of from 5 to 100% by weight, preferably from 5 to 50% by weight and particularly preferably from 10 to 40% by weight of an ethylenically unsaturated carboxylic anhydride or of an ethylenically unsaturated dicarboxylic acid whose carboxyl groups may form an anhydride group.

Such carboxylic anhydrides or dicarboxylic acids are in particular maleic acid, maleic anhydride, itaconic acid, norbornenedicarboxylic acid, 1,2,3,6-tetrahydrophthalic acid and 1,2,3,6-tetrahydrophthalic anhydride.

Maleic acid and maleic anhydride are particularly preferred.

In addition to the above monomers, the polymer may consist of any desired further monomers. The monomers are preferably chosen so that the polymer is soluble in water (21° C., 1 bar). In the case of the particularly preferred polymer having the above content of an ethylenically unsaturated carboxylic anhydride or of an ethylenically unsaturated dicarboxylic acid, the polymer can in particular also comprise monomers having a carboxyl group. For example, copolymers of maleic acid or maleic anhydride with acrylic acid or methacrylic acid are suitable.

For example, ethene, propene, butene, isobutene, cyclopentene, methyl vinyl ether, ethyl vinyl ether, acrylamide, 2-acrylamido-2-methylpropanesulfonic acid, vinyl acetate, styrene, butadiene and/or acrylonitrile may be mentioned as further monomers which may be incorporated in the form of polymerized units in the polymer, in addition to the monomers having an acid or acid anhydride group.

Ethene, acrylamide, styrene and/or acrylonitrile are particularly preferred.

The acid groups in the polymer may also be present in the form of salts, e.g. ammonium or alkali metal cations.

Suitable crosslinking agents are compounds having hydroxyl groups or amino groups, in particular having at least two hydroxyl groups or amino groups in the molecule.

Particularly preferred crosslinking agents are those having hydroxyl groups. The crosslinking agent preferably comprises at least two hydroxyl groups in the molecule.

These may be, for example, low molecular weight alcohols, such as glycol or glycerol.

Alkanolamines which have at least two hydroxyl groups are particularly preferred.

Alkanolamines of the formula (I)

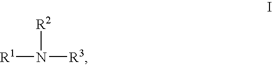

where R¹ is an H atom, a C1-C10-alkyl group or a C2-C10-hydroxyalkyl group and R² and R³ are a C2-C10-hydroxyalkyl group, are preferred.

Particularly preferably, R² and R³, independently of one another, are a C2-C5-hydroxyalkyl group and R1 is an H atom, a C1-C5-alkyl group or a C2-C5-hydroxyalkyl group.

In particular, diethanolamine, triethanolamine, diisopropanolamine, triisopropanolamine, methyldiethanolamine, butyldiethanolamine and methyldiisopropanolamine may be mentioned as compounds of the formula (I). Triethanolamine is particularly preferred.

The polymer and the crosslinking agent, for example, the alkanolamine, are preferably used in a ratio to one another such that the molar ratio of carboxyl groups of the polymer to the hydroxyl groups or amino groups of the crosslinking agent is from 20:1 to 1:1, preferably from 8:1 to 5:1 and particularly preferably from 5:1 to 1.7:1 (anhydride groups are calculated here as two carboxyl groups).

The two-component binder is prepared, for example, in a simple manner by addition of the crosslinking agent to the solution of the polymer.

Regarding the Preparation of the Consolidated Beads

The beads are mixed with the binder. Here, the term mix is to be understood as meaning any method of bringing into contact. The beads can, for example, be impregnated with the binder, the binder can be added to a dispersion of the beads in a solvent or the beads can be added to a solution or dispersion of the binder.

In a preferred embodiment, the beads are added to the aqueous binder solution, the solution is stirred, preferably for a sufficient time, and the beads are thus impregnated and penetrated by the binder. This mixing process can be carried out at temperatures of from 0 to 80° C., preferably at from 10 to 40° C., in particular at room temperature (from 18 to 30° C.).

Thereafter, the beads can be filtered off. For crosslinking the binder, the beads obtained can be dried and can be crosslinked at the crosslinking temperature required depending on the binder. The drying can be effected, for example, at temperatures of from 20 to 100° C. and the crosslinking can be effected likewise, at least in some cases, at these temperatures; preferably, the temperature for the crosslinking is increased to above 100° C., for example from 100 to 200° C. After 2 to 30 minutes at this elevated temperature, complete crosslinking has generally taken place.

The consolidated beads obtained preferably have a binder content of at least 5% by weight, particularly preferably of at least 10, very particularly preferably at least 20, % by weight, based on the total weight of the dry beads.

The beads otherwise substantially comprise cellulose or lignocellulose. However, they may also comprise other constituents, for example additives, such as stabilizers, biocides, etc.

Overall, the consolidated beads may be composed of:
a) from 40 to 90% by weight, particularly preferably from 40 to 80% by weight, of cellulose or lignocellulose
b) from 10 to 90% by weight, particularly preferably from 10 to 60% by weight, of binder and
c) from 0 to 20% by weight, particularly preferably from 0 to 10% by weight, of other constituents.

In a particular embodiment, the beads comprise biocides, preferably in an amount of from 0.1 to 3% by weight.

All stated weights are based on the weight of the dried, consolidated beads.

Preferably, at least 50% by weight, particularly preferably at least 80% by weight, very particularly preferably at least 90% by weight, in particular at least 95% by weight, of the consolidated beads have a particle diameter greater than 800 μm (21° C., 1 bar, determined by sieve analysis).

Preferably at least 95% by weight, in particular at least 99% by weight, of the consolidated beads have a particle diameter of less than 1500 μm.

Preferred consolidated beads therefore have a binder content greater than 10% by weight, in particular at least 20% by weight, and a proportion of at least 50% by weight of beads having a particle diameter greater than 800 μm (21° C., 1 bar, determined by sieve analysis).

The consolidated beads preferably have an increase in diameter of less than 20%, in particular less than 10% and very particularly preferably less than 5% or even less than 2% after swelling in 2% strength by weight aqueous potassium chloride solution.

The increase in diameter after swelling is determined as follows:

The consolidated beads are dried at 105° C., 1 bar to constant weight. 1 gram of the beads is added to 10 grams of 2% strength by weight potassium chloride solution (at 21° C., 1 bar). After 24 hours, the swollen beads are removed from the solution and the diameter is determined directly thereafter under the microscope without drying and is compared with the diameter of the beads dried at 105° C. and 1 bar to constant weight without swelling.

In the microscopic evaluation, the mean value of the bead diameter of at least 20 beads is determined.

Particularly preferred consolidated beads have a binder content greater than 20% by weight and a proportion of at least 50% by weight of beads having a particle diameter greater than 800 μm (21° C., 1 bar, determined by sieve analysis) and an increase in diameter of less than 2% by weight after swelling.

In spite of their size, the consolidated beads according to the invention are extremely strong. They are therefore advantageous in transport, storage and disposal. During their use, there is scarcely any abrasion or comminution due to impacts or friction or due to the action of other forces, including shear forces.

### EXAMPLES

Binder: Acrodur® 950 L, an aqueous solution comprising a maleic acid copolymer and an alkanolamine as crosslinking agent

Fine fraction:

In the examples, fine fraction is understood as meaning beads having a diameter of less than 800 μm.

Test methods:

Pressure test:

The consolidated cellulose beads (dry) were introduced into a cylindrical container and a pressure of 100 kiloNewton was exerted on the beads for 2 minutes by means of a movable ram. The fraction of crushed beads (fine fraction) was then determined.

### Example 1

### Crosslinking with 10% Strength by Weight Acrodur Solution

250 g of moist cellulose beads (corresponds to 33 g of dry cellulose beads, solids content of 13.2%) were weighed into a beaker. 660 g of Acrodur 950 L (10% strength) were added thereto and stirred for 1 h at room temperature and 350 rpm. The cellulose beads were filtered. The samples were dried at 70° C. in a fluidized bed and then crosslinked at 180° C. in the course of 14 minutes.

Swelling value in 2% by weight KCl solution: 13% increase in diameter

Bulk density: 0.85 g/cm³

Sieve size: 800-1800 μm (corresponds to US sieve 12/20)

Pressure test: 38.1% fine fraction

### Example 2

### Crosslinking with 20% Strength by Weight Acrodur Solution

250 g of moist cellulose beads (corresponds to 33 g of dry cellulose beads, solids content of 13.2%) were weighed into a beaker. 660 g of Acrodur 950 L (20% strength) were added thereto and stirred for 1 h at room temperature and 350 rpm. The cellulose beads were filtered. The samples were dried at 70° C. in a fluidized bed and then crosslinked at 180° C. in the course of 16 minutes.

Swelling value in 2% by weight KCl solution: 0% increase in diameter

Bulk density: 0.94 g/cm³

Sieve size: 800-1800 μm (corresponds to US sieve 12/20)

Pressure test: 1.0% fine fraction

### Example 3

### Crosslinking with 30% Acrodur Solution

260 g of moist cellulose beads (corresponds to 33 g of dry cellulose beads, solids content of 12.7%) were weighed into a beaker. 660 ml of 0.1% by mass of NaOH solution were added thereto and stirred for 1 h at room temperature. The beads were filtered off without pressure. 660 g of Acrodur 950 L solution (30% strength) were added and stirred for 1 h at room temperature. The cellulose beads were filtered off. The samples were dried for 1 h at 70° C. and then for 1 h at 180° C. in a drying oven.

Swelling value in 2% by weight KCl solution: 6% increase in diameter

Bulk density: 0.86 g/cm³

Sieve size: 800-1800 μm (corresponds to US sieve 12/20)

Pressure test: 7.5% fine fraction

1. A binder-consolidated cellulose bead or lignocellulose bead (referred to as consolidated bead for short), obtainable by
mixing of cellulose or lignocellulose bead with a binder
and subsequent crosslinking of the binder.

2. The consolidated bead according to claim 1, wherein at least 50% by weight of the beads obtained have a particle diameter greater than 800 μm (21° C., 1 bar, determined by sieve analysis).

3. The consolidated bead according to claim 1, wherein the binder is a binder dissolved in water or in an organic solvent.

4. The consolidated bead according to claim 1, wherein the binder is a one-component or two-component binder which is crosslinked by a condensation reaction.

5. The consolidated bead according to claim 1, wherein the binder is a water-soluble formaldehyde resin.

6. The consolidated bead according to claim 1, wherein the binder is a two-component binder comprising
a) a water-soluble polymer having carboxyl acid or carboxylic anhydride groups and
b) a crosslinking agent for the carboxyl acid or carboxylic anhydride groups.

7. The consolidated bead according to claim 6, wherein the crosslinking agent is a compound having at least two hydroxyl groups.

8. The consolidated bead according to claim 1, wherein the binder is a two-component binder comprising
a) a water-soluble polymer having a content of at least 5 to 100% by weight of maleic acid or maleic anhydride and
b) an alkanolamine as a crosslinking agent.

9. The consolidated bead according to claim 1, wherein the proportion by weight of the binder is from 10 to 60% by weight, based on the bead.

10. The consolidated bead according to claim 1, having a binder content greater than 10% by weight and a proportion of at least 50% by weight of beads having a particle diameter greater than 800 μm (21° C., 1 bar, determined by sieve analysis).

11. The consolidated bead according to claim 1, having a binder content greater than 10% by weight and a proportion of at least 50% by weight of beads having a particle diameter greater than 800 μm (21° C., 1 bar, determined by sieve analysis) and an increase in diameter of less than 5% after swelling in 2% strength by weight aqueous potassium chloride solution.

12. The consolidated bead according to claim 1, having a binder content greater than 10% by weight and a proportion of at least 50% by weight of beads having a particle diameter greater than 800 μm (21° C., 1 bar, determined by sieve analysis) and an increase in diameter of less than 5% after swelling in 2% strength by weight aqueous potassium chloride solution and a content of biocides.

13. The consolidated bead according to claim 2, wherein the binder is a binder dissolved in water or in an organic solvent.

14. The consolidated bead according to claim 2, wherein the binder is a one-component or two-component binder which is crosslinked by a condensation reaction.

15. The consolidated bead according to claim 3, wherein the binder is a one-component or two-component binder which is crosslinked by a condensation reaction.

16. The consolidated bead according to claim 2, wherein the binder is a water-soluble formaldehyde resin.

17. The consolidated bead according to claim 3, wherein the binder is a water-soluble formaldehyde resin.

18. The consolidated bead according to claim 4, wherein the binder is a water-soluble formaldehyde resin.

19. The consolidated bead according to claim 2, wherein the binder is a water-soluble formaldehyde resin.

20. The consolidated bead according to claim 3, wherein the binder is a water-soluble formaldehyde resin.
